(19) United States
(12) Patent Application Publication
(10) Pub. No.: US 2024/0324842 A1
(43) Pub. Date: Oct. 3, 2024

(54) BASE STATION AND CLEANING ROBOT SYSTEM

(71) Applicant: Beijing Roborock Technology Co., Ltd., Changping District, Beijing (CN)

(72) Inventors: Xing LI, Changping District, Beijing (CN); Chuanlin DUAN, Changping District, Beijing (CN); Zhimin YANG, Changping District, Beijing (CN)

(21) Appl. No.: 18/579,814

(22) PCT Filed: Mar. 21, 2022
(86) PCT No.: PCT/CN2022/082061

§ 371 Date: Jan. 16, 2024

(30) Foreign Application Priority Data
Jul. 16, 2021 (CN) 202110805968.1
Aug. 27, 2021 (CN) 202122051444.6

(51) Int. Cl. A47L 11/40

(52) U.S. Cl. CPC A47L 11/4091; A47L 2201/02

(57) ABSTRACT

Disclosed are a base station and a cleaning robot system. The base station is used for maintenance of a cleaning robot. The base station includes: a base station body, and a base station baseboard having a slope portion tilted upward from back to front. The base station baseboard includes a substrate and an extension plate, a front end of the substrate is engaged with the base station body, and a rear end of the substrate is connected to the extension plate.

### CROSS-REFERENCE TO RELATED APPLICATION

This application is based upon and claims priority to Chinese Patent Application No. 202110805968.1, filed on Jul. 16, 2021 and Chinese Patent Application No. 202122051444.6, filed on Aug. 27, 2021, which are incorporated herein by reference in their entireties.

### TECHNICAL FIELD

The present disclosure relates to the field of smart home technologies, more particularly to a base station and a cleaning robot system.

### BACKGROUND ART

At present, the cleaning robot is generally required to move actively to a suitable location of the base station to obtain maintenance operations such as charging, water replenishment, cleaning and the like from the base station. However, when encountering a slippery ground, the climbing operation of the cleaning robot may be affected.

### SUMMARY OF THE INVENTION

A series of concepts in simplified form are introduced in the summary section, and will be described in further detail in the detailed description section. This section of the present disclosure is not indented to limit key features and necessary technical features of the technical solution as claimed, let alone to attempt to determine the protection scope of the technical solution as claimed.

According to embodiments of a first aspect of the present disclosure, a base station for maintenance of a cleaning robot is provided. The base station includes a base station body and a base station baseboard having a slope portion tilted upward from back to front, wherein the base station baseboard includes a substrate and an extension plate, a front end of the substrate is engaged with the base station body, and a rear end of the substrate is connected to the extension plate.

In some embodiments, the extension plate is pivotally connected to the substrate, and the extension plate has a folded state and an unfolded state with respect to the substrate.

In some embodiments, an accommodation slot is provided at a bottom of the substrate, and the extension plate is accommodated in the accommodation slot when it is in the folded state.

In some embodiments, a first anti-slip portion and a second anti-slip portion are respectively provided on the extension plate and the substrate for a travelling device of the cleaning robot to pass therethrough.

In some embodiments, the first anti-slip portions are symmetrically provided on the extension plate, and the second anti-slip portions are symmetrically provided on the substrate.

In some embodiments, an avoidance slot is provided on the substrate, the avoidance slot being provided between the second anti-slip portions and configured to accommodate a part of the cleaning robot when the cleaning robot passes through the base station baseboard.

In some embodiments, a support wheel is provided at two sides of the avoidance slot, and configured to support the cleaning robot when the cleaning robot passes through or docks on the base station baseboard.

In some embodiments, a recessed structure is provided at a rear end of the extension plate for the travelling device of the cleaning robot to pass therethrough.

In some embodiments, the recessed structure is located at a middle position of the rear end of the extension plate.

In some embodiments, a first guide surface is provided along a circumference of the recessed structure, and is provided slantwise from inside to outside.

In some embodiments, the base station body is provided with a guide portion disposed above the substrate for contacting with the cleaning robot.

In some embodiments, the base station body is provided with a top guide surface opposite to the substrate, and the guide portion is provided on a middle portion of the top guide surface and/or at two sides of the middle portion.

In some embodiments, the guide portion is provided at a front end of the top guide surface.

In some embodiments, the guide portion includes a guide press block, wherein a side of the guide press block facing the substrate is provided as a first slope, and the first slope is tilted downward from back to front.

In some embodiments, the guide portion includes a guide wheel, and the guide wheel rotates about an axis perpendicular to a front-rear direction of the base station.

In some embodiments, the top guide surface is provided with a mounting bracket, and the guide wheel is mounted to the mounting bracket by a rotation shaft.

According to embodiments of a second aspect of the present disclosure, a cleaning robot system is provided. The cleaning robot system includes: a cleaning robot; and a base station according to any one of the first aspect, the cleaning robot being adapted to dock at the base station.

### BRIEF DESCRIPTION OF THE DRAWINGS

The following accompanying drawings of the present disclosure are taken herein as a part of the embodiments of the present disclosure for the purpose of understanding the present disclosure. The accompanying drawings illustrate embodiments of the present disclosure and descriptions thereof for explaining the principles of the present disclosure.

In the drawings:

FIG. 1 is a schematic structural diagram of a cleaning robot system according to an embodiment of the present disclosure;

FIG. 2 is a schematic structural diagram of a cleaning robot according to an embodiment of the present disclosure;

FIG. 3 is a schematic structural diagram of a perspective of an embodiment shown in FIG. 2;

FIG. 4 is a partial schematic exploded diagram of an embodiment shown in FIG. 3;

FIG. 5 is a schematic structural diagram of a base station according to an embodiment of the present disclosure;

FIG. 6 is a schematic structural diagram of an extension plate in an unfolded state with respect to a substrate according to an embodiment of the present disclosure;

FIG. 7 is a schematic structural diagram of an extension plate in a folded state with respect to a substrate according to an embodiment of the present disclosure;

FIG. 8 is a partial schematic structural diagram of a perspective of an embodiment shown in FIG. 7;

FIG. 9 is a partial schematic structural diagram of another perspective of an embodiment shown in FIG. 7;

FIG. 10 is a partial schematic structural diagram of a perspective of an embodiment shown in FIG. 6;

FIG. 11 is a partial schematic structural diagram of an embodiment shown in FIG. 1;

FIG. 12 is a schematic structural diagram of a cleaning robot according to another embodiment of the present disclosure;

FIG. 13 is a schematic structural diagram of a base station according to an embodiment of the present disclosure; and

FIG. 14 is a partially enlarged schematic diagram of part A of an embodiment shown in FIG. 13.

### LIST OF REFERENCE NUMERALS

10-cleaning robot, 110-machine body, 111-forward portion, 112-backward portion, 120-perception system, 121-determining device, 122-buffer, 130-control module, 140-driving system, 141-driving wheel module, 142-driven wheel, 150-cleaning system, 151-dry cleaning system, 152-side brush, 153-wet cleaning system, 1531-cleaning head, 1532-driving unit, 1533-driving platform, 1534-support platform, 160-energy system, 170-human-computer interaction system, 180-rotating wheel, 20-base station, 210-base station baseboard, 211-slope portion, 2111-avoidance slot, 2112-support wheel, 212-recessed structure, 2121-first guide surface, 214-substrate, 2141-accommodation slot, 2142-second anti-slip portion, 2143-support portion, 215-extension plate: 2151-first anti-slip portion, 216-cleaning slot, 217-flat portion, 218-pivoting axis, 2191-first track, 2192-second track, 220-base station body, 221-guide portion, 222-guide press block, 2221-first slope, 223-guide wheel, 224-top guide surface, 225-side guide surface, 2251-side surface, 2252-intermediate surface, 226-mounting bracket, 2261-first bracket body, 2262-second bracket body, 227-rotation shaft, 30-cleaning assembly.

### DETAILED DESCRIPTION

In the description that follows, a great deal of specific detail is given to provide a more thorough understanding of technical solutions of the present disclosure. However, it may be apparent to those skilled in the art that technical solutions of the present disclosure can be implemented without one or more of these details.

It shall be noted that the terms used herein are merely intended to describe specific embodiments and are not intended to limit exemplary embodiments according to the present disclosure. As used here, the singular form is also intended to include the plural form, unless the context clearly indicates otherwise. It shall also be understood that the terms “comprising” and/or “including” as used in this specification may indicate the presence of the features, integers, steps, operations, components and/or assemblies, which do not exclude the presence or addition of one or more other features, integers, steps, operations, components, assemblies and/or combinations thereof.

Exemplary embodiments of the present disclosure will be described herein in more detail with reference to the accompanying drawings. However, these exemplary embodiments may be implemented in a variety of different forms and shall not be construed as being limited to the embodiments set forth herein. It shall be understood that these embodiments are provided to make the present disclosure thorough and complete and to fully communicate the ideas of these exemplary embodiments to those of ordinary skill in the art.

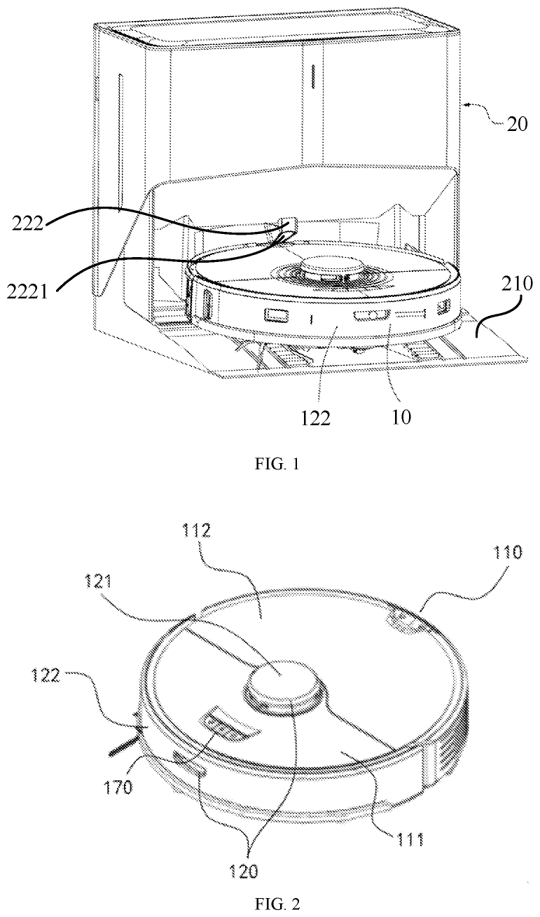

As shown in FIG. 1 to FIG. 14, embodiments of the present disclosure provide a base station 20 and a cleaning robot system. As shown in FIG. 1, the cleaning robot system includes a cleaning robot 10 and a base station 20. That is, the base station 20 is used in cooperation with the cleaning robot 10.

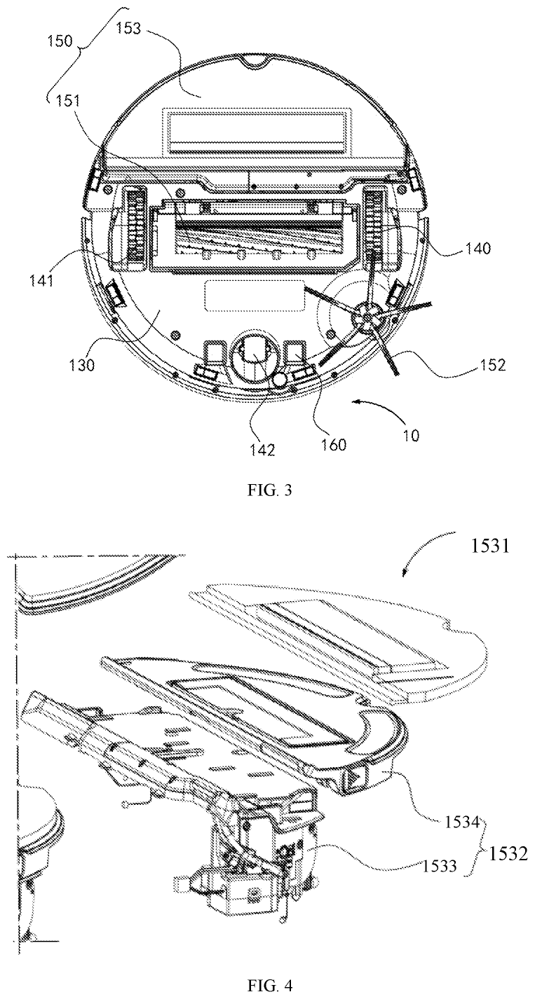

In some embodiments, as shown in FIGS. 2 and 3, the cleaning robot 10 may include a machine body 110, a perception system 120, a control module 130, a driving system 140, a cleaning system 150, an energy system 160, and a human-computer interaction system 170. It will be appreciated that the cleaning robot 10 may be a self-moving cleaning robot or other cleaning robot that meets the requirements. The self-moving cleaning robot is an apparatus that automatically performs cleaning in a region to be cleaned without a user operation. When the self-moving cleaning robot starts working, the self-moving cleaning device departs from the base station 20 to perform the cleaning task. The self-moving cleaning robot 10 may return to the base station 20 for recharging or other operations when the self-moving cleaning robot 10 completes its cleaning task or other situations that require aborting the cleaning task.

As shown in FIG. 2, the machine body 110 includes a forward portion 111 and a backward portion 112 both having a nearly circular shape (both the front and rear portions being circular), and may also have other shapes including, but not limited to, a nearly D-shaped shape with a square front and circular rear and a rectangular or square shape with a square front and square rear.

As shown in FIG. 2, the perception system 120 includes: a position determining device 121 provided on the machine body 110, a collision sensor and a proximity sensor provided on the buffer 122 of the forward portion 111 of the machine body 110, a cliff sensor provided on a lower portion of the machine body 110, and sensing devices such as a magnetometer, an accelerometer, a gyroscope, and an odometer provided inside the machine body 110 for providing various location information and motion state information of the machine to the control module 130. The position determining device 121 includes, but is not limited to, a camera and a Laser Distance Sensor (LDS).

As shown in FIG. 2, the forward portion 111 of the machine body 110 carries the buffer 122. During cleaning, when the driving wheel module 141 propels the cleaning robot 10 to travel on the ground, the buffer 122 detects one or more events in a travelling path of the cleaning robot 10 via a sensor system disposed thereon, e.g., an infrared sensor, and the cleaning robot 10 may control the driving wheel module 141 based on the event, such as obstacle and wall, detected by the buffer 122 to cause the cleaning robot 10 to respond to the event, for example, to move away from the obstacle.

The control module 130 is provided on a circuit motherboard within the machine body 110 and includes a computational processor, such as a central processing unit, an application processor in communication with a non-transitory memory, such as a hard disk, a flash memory. a random access memory. The application processor draws an instant map of the environment in which the cleaning robot 10 is located using a positioning algorithm, such as simultaneous localization and mapping (SLAM), based on the obstacle information fed back by the laser ranging device. In addition, based on distance information and speed information as fed back by sensing devices such as the sensor, the cliff sensor, the magnetometer, the accelerometer, the gyroscope and the odometer provided on the buffer 122, a current operation state, a current location, and a current pose of the cleaning robot 10, such as crossing a threshold, getting on a carpet, locating at an edge of a cliff, being trapped from above or below, having a full dust box or being picked up, can be comprehensively determined. In addition, specific next-step action strategies may be given for different situations, so that the cleaning robot 10 has a better cleaning performance and user experience.

As shown in FIG. 3, the driving system 140 may execute a driving command based on the distance and angle information, such as x, y, and theta components, to manipulate the machine body 110 to travel across the ground. The driving system 140 includes a driving wheel module 141, and the driving wheel module 141 may control a left wheel and a right wheel simultaneously. In order to control the motion of the machine more precisely, the driving wheel module 141 may include a left driving wheel module and a right driving wheel module respectively. The left and right driving wheel modules are provided along a lateral axis defined by the machine body 110. In order for the cleaning robot 10 to move on the ground more stably or have a stronger movement ability, the cleaning robot 10 may include one or more driven wheels 142 that includes but is not limited to a driven wheel. The driving wheel module 141 includes a travelling wheel, a driving motor, and a control circuit to control the driving motor, and the driving wheel module 141 may also be connected to a circuit for measuring the driving current and an odometer. The driving wheel may have a biased drop suspension system, is fastened in a removable manner, such as being attached to the machine body 110 in a rotatable manner, and receives a spring offset biased downward and away from the machine body 110. The spring offset allows the driving wheel to maintain contact with the ground and traction with a certain landing force, and meanwhile, the cleaning elements of the cleaning robot 10 may also contact the ground with a certain pressure.

The energy system 160 includes a rechargeable battery, such as a nickel-hydride battery and a lithium battery. The rechargeable battery may be connected with a charging control circuit, a battery pack charging temperature detecting circuit and a battery undervoltage monitoring circuit, wherein the charging control circuit, the battery pack charging temperature detecting circuit and the battery undervoltage monitoring circuit are then connected to a single-chip microcomputer control circuit. A host of the automatic cleaning apparatus is connected to a charging pile through a charging electrode disposed on a side of or below a body of the automatic cleaning apparatus for charging.

The human-computer interaction system 170 includes buttons that are on a panel of the host and used by a user to select functions. The human-computer interaction system 170 may further include a display screen and/or an indicator light and/or a horn that present a current state or function item of the automatic cleaning apparatus to the user. The human-computer interaction system 170 may further include a mobile client program. For a route navigation type automatic cleaning apparatus, a mobile client may present a map of the environment where the apparatus is located and a position of the robot to the user, which may provide richer and more user-friendly function items to the user.

The cleaning system 150 may be a dry cleaning system 151 and/or a wet cleaning system 153.

As shown in FIG. 3, the dry cleaning system 151 according to embodiments of the present disclosure may include a rolling brush, a dust box, a blower and an air outlet. The rolling brush having a certain interference with the ground sweeps up garbage on the ground and rolls up the garbage to the front of a dust suction inlet between the rolling brush and the dust box, and then the garbage is sucked into the dust box by air having a suction force, which is generated by the blower and passes through the dust box. The dry cleaning system 151 may further include a side brush 152 having a rotation shaft angled relative to the ground, for moving debris into a region of the rolling brush of the cleaning system 150.

As shown in FIG. 3 and FIG. 4, the wet cleaning system 153 according to embodiments of the present disclosure may include a cleaning head 1531, a driving unit 1532, a water delivery mechanism, and a liquid storage tank. The cleaning head 1531 may be provided below the liquid storage tank, and the cleaning liquid inside the liquid storage tank is transferred to the cleaning head 1531 through the water delivery mechanism to enable the cleaning head 1531 to wet-clean the plane to be cleaned. In other embodiments of the present disclosure, the cleaning liquid inside the liquid storage tank may also be sprayed directly onto the plane to be cleaned, and the cleaning head 1531 achieves cleaning of the plane by applying the cleaning liquid evenly.

The cleaning head 1531 is configured to clean the surface to be cleaned, and the driving unit 1532 is configured to drive the cleaning head 1531 to substantially reciprocate along the target surface, the target surfacing being a portion of the surface to be cleaned. The cleaning head 1531 reciprocates along a surface to be cleaned, and a surface of the cleaning head 1531 in contact with the surface to be cleaned is provided with a cleaning cloth or a cleaning plate, which generates a high-frequency friction with the surface to be cleaned through reciprocating motion, thereby removing stains on the surface to be cleaned.

In embodiments of the present disclosure, as shown in FIG. 4, the driving unit 1532 may further include: a driving platform 1534 connected to a bottom surface of the machine body 110 for providing a driving force; and a support platform 1534 removably connected to the driving platform 1533 for supporting the cleaning head 1531 and being able to lift and lower under the driving of the driving platform 1533.

As embodiments of the present disclosure, the wet cleaning system 153 may be connected to the machine body 110 by an active lifting and lowering module. The wet cleaning system 153 is lifted by the active lifting and lowering module when the wet cleaning system 153 is temporarily not involved in working, for example, when the cleaning robot 10 docks at the base station 20 to clean the cleaning head 1531 of the wet cleaning system 153 or to fill the liquid storage tank with water, or when the surface to be cleaned as encountered cannot be cleaned with the wet cleaning system 153.

In the wet cleaning system 153 according to embodiments of the present disclosure, the cleaning head 1531, the driving platform 1533, the support platform 1534, the water delivery mechanism, and the liquid storage tank can be powered by one or more motors. The energy system 160 provides power and energy for the motor and is entirely controlled by the control module 130.

The water delivery mechanism according to embodiments of the present disclosure includes a water discharging device that may be directly or indirectly connected to a liquid outlet of a liquid storage tank. The cleaning liquid may flow to the water discharging device via the cleaning liquid outlet of the liquid storage tank, and may be evenly applied on the surface to be cleaned through the water discharging device. A connecting member may be provided on the water discharging device, and the water discharging device is connected to the cleaning liquid outlet of the liquid storage tank through the connecting member. The water discharging device is provided with a distribution port which may be a continuous opening or a combination of several discontinuous small openings, and several nozzles may be provided at the distribution port. The cleaning liquid flows to the distribution port via the cleaning liquid outlet of the liquid storage tank and the connecting member of the water discharging device, and is evenly applied on the surface to be cleaned via the distribution port.

In embodiments of the present disclosure, the liquid storage tank further includes a water replenishing port, and the water replenishing port may be disposed on a side wall of the tank. When the cleaning robot 10 docks on the base station 20, the base station 20 may replenish water to the liquid storage tank of the cleaning robot 10 via the water replenishing port.

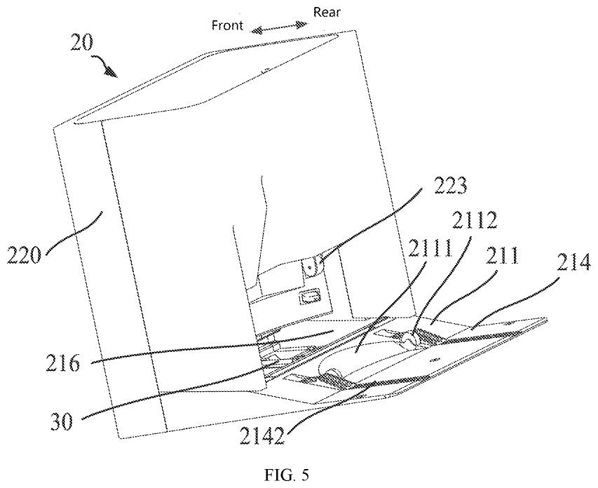

In embodiments according to the present disclosure, as shown in FIGS. 5 to 10, the base station 20 includes a base station body 220 and a base station baseboard 210, and the base station baseboard 210 includes a substrate 214 and an extension plate 215. The front end of the substrate 214 is engaged with the base station body 220, the rear end of the substrate 214 is connected to the extension plate 215, and the base station baseboard 210 includes a slope portion 211 tilted upward from back to front. The front-rear direction of the base station is shown by the arrow in FIG. 5, and the slope portion 211 is configured to guide the cleaning robot 10 to move to a suitable location of the base station 20 for other operations such as charging. That is, the travelling devices of the cleaning robot 10 such as driving wheels and universal wheels can dock at a suitable location of the base station 20 only if passing through the slope portion 211. In some embodiments, the cleaning robot 10 can dock at a suitable location of the base station for corresponding operations only if passing through the slope portion along the rear-to-front direction of the base station 20. For example, the cleaning robot may dock on the base station for charging, which means that the travelling direction of the cleaning robot 10 is towards the front of the base station 20.

The extension plate 215 may be connected to the rear end of the substrate 214, and may, for example, provided at the rear end of the substrate 214 removably or movably. In case of special circumstances such as a slippery ground and the like, the extension plate 215 may be connected to the substrate 214 and placed at the rear of the substrate 214, such that the cleaning robot 10 that is approaching the base station 20 can reach the slope portion 211 on the substrate 214 after passing through the extension plate 215, thereby helping the cleaning robot 10 to climb the slope. As a result, the efficiency and reliability of the cleaning robot 10 in docking at the base station 20 can be improved, which is thereby suitable for popularization and application.

In some embodiments, on one hand, the extension plate 215 is removably connected to the substrate 214. For example, when the extension plate 215 is needed, the extension plate 215 may be connected to the rear end of the substrate 214 to help the cleaning robot 10 to climb the slope; and when the extension plate 215 is not needed, the extension plate 215 may be disassembled from the substrate 214 for storage, which is simple in operation.

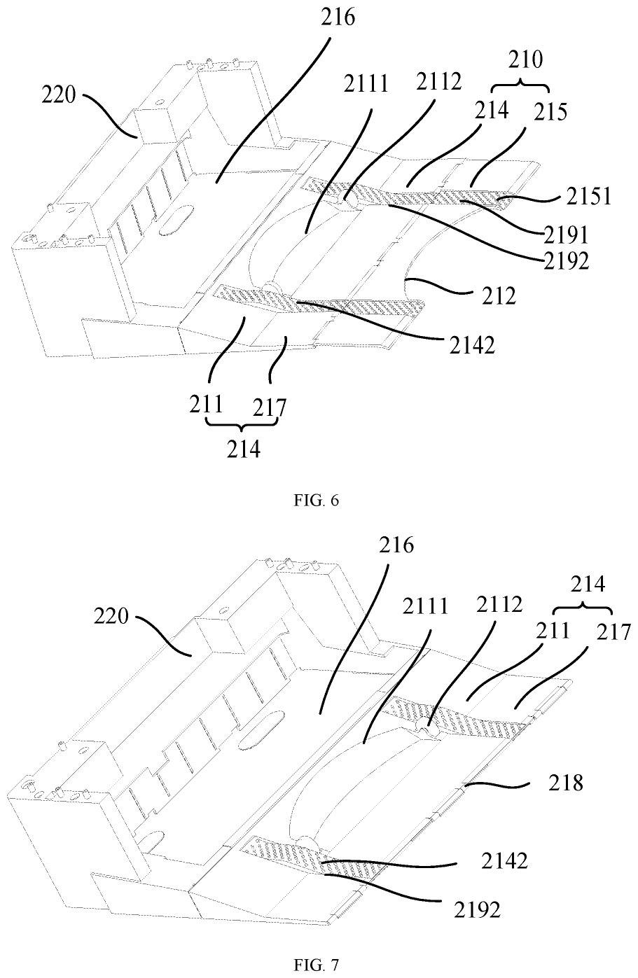

On the other hand, as shown in FIGS. 6 and 7, the extension plate 215 is movably connected to the substrate 214, such that the extension plate 215 is movable relative to the substrate 214. When the extension plate 215 is needed, the extension plate 215 may move relative to the substrate 214 and docks behind the substrate 214 to help the cleaning robot 10 to climb the slope; and when the extension plate 215 is not needed, the extension plate 215 may move relative to the substrate 214 to other positions meeting the requirement of storage, which is simple in operation.

That is, with the movable connection or removable connection between the extension plate 215 and the substrate 214, the requirement of different working conditions in needing or not needing the extension plate 215 when the cleaning robot 10 docks at the base station 20 can be met. That is, when there is a special requirement, for example, when the ground is slippery, the extension plate 215 and the substrate 214 may form the base station baseboard 210 to enable the cleaning robot 10 to dock on the base station 20; and when there is no special requirement, for example, when the ground is dry, the substrate 214 by itself can enable the cleaning robot 10 to dock on the base station 20, and the extension plate 215 which is not needed at this point is received at a suitable location, which expands the usage range of the product and is thereby suitable for popularization and application.

The front end of the substrate 214 is engaged with the base station body 220. In some embodiments, the front end of the substrate 214 may be engaged with the base station body 220 by welding, one-piece molding, or other means that meet the requirements, which is not specifically limited in the present disclosure.

In aforesaid embodiments, as shown in FIGS. 6 and 7, the extension plate 215 is pivotally connected to the substrate 214, and the extension plate 215 may be in a folded state or an unfolded state with respect to the substrate 214. For example, the base station 20 may further include a pivoting axis 218, and the extension plate 215 is connected to the substrate 214 by the pivoting axis 218. As a result, when the extension plate 215 is needed, the extension plate 215 is rotated relative to the substrate 214 to the rear of the substrate 214, thereby helping the cleaning robot 10 to climb the slope; and when the extension plate 215 is not needed, the extension plate 215 is pivoted to overlap with the substrate 214 and is then folded relative to the substrate 214, which facilitates the storage of the extension plate 215 and does not affect the size of the substrate 214 along the front-rear direction, and thereby can meet the requirement under the working condition of not needing the extension plate 215 when the cleaning robot 10 docks at the base station 20. It will be appreciated that the extension plate 215 and the substrate 214 may also be connected to each other with other structures that meet the requirements, which is not specifically limited by the present disclosure.

In some embodiments, the extension plate 215 is a foldable structure, which means that the extension plate 215 itself can be folded. This configuration helps to increase the length of the extension plate 215, facilitates the storage of the extension plate 215, and is suitable for popularization and application.

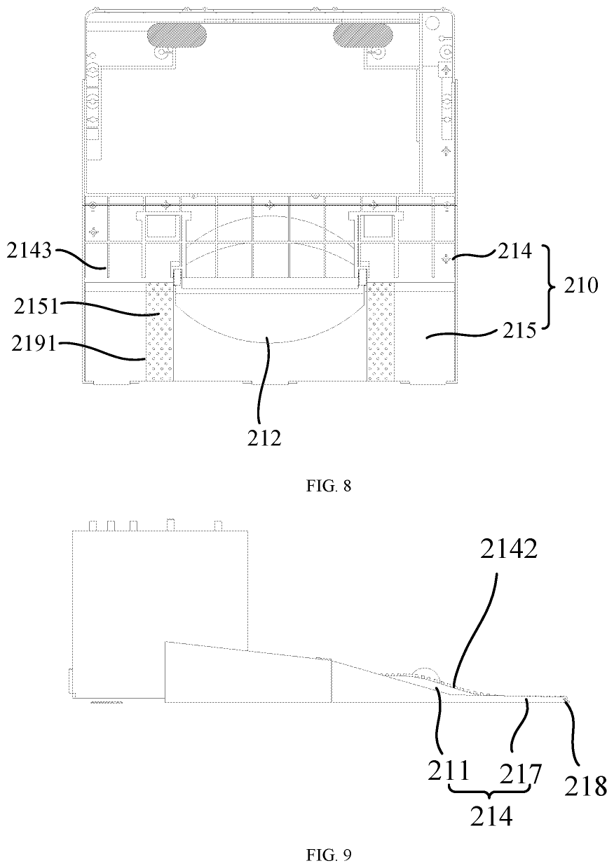

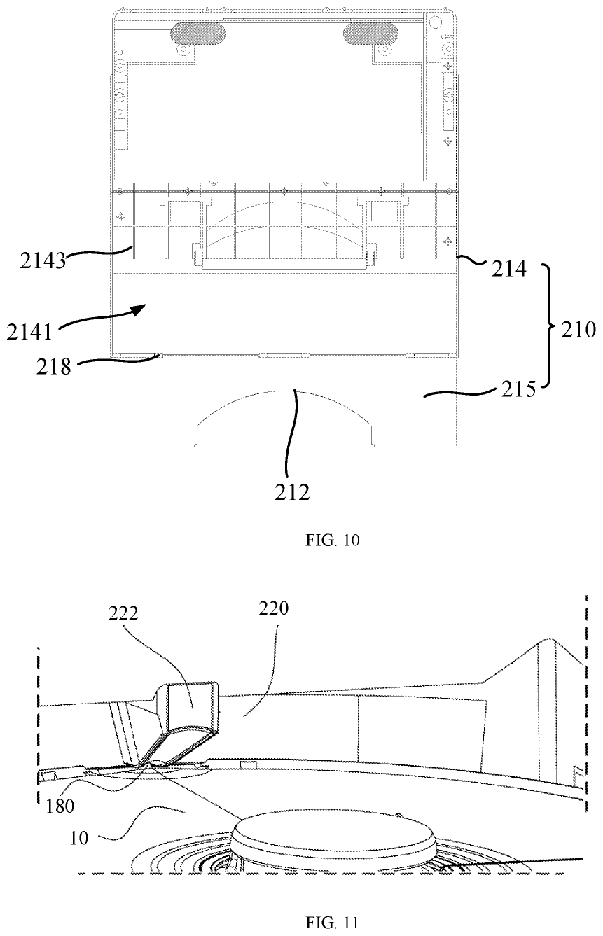

In aforesaid embodiments, as shown in FIG. 8 and FIG. 10, FIG. 8 is a bottom view of a perspective of FIG. 7, and FIG. 10 is a bottom view of a perspective of FIG. 6. As shown in FIG. 10, an accommodation slot 2141 is provided at the bottom of the substrate 214. It will be appreciated that the accommodation slot 2141 may also be other structures having an accommodation space, and the accommodation slot 2141 is communicated with the rear end of the substrate 214, which means that the accommodation slot 2141 is an open slot. As shown in FIG. 8, when the extension plate 215 is folded with respect to the substrate 214, the extension plate 215 is accommodated in the accommodation slot 2141. The provision of the accommodation slot 2141 provides a storage space for the extension plate 215. In addition, the accommodation slot 2141 which is located at the bottom of the substrate 214 will not affect the aesthetic appearance of the substrate 214, and meanwhile not affect the structure of the upper surface of the substrate 214 and the height of the substrate 214, thereby ensuring that the cleaning robot 10 can dock smoothly on the base station 20 along the upper surface of the substrate 214.

In one example, as shown in FIGS. 8 and 10, a support portion 2143 protruding downwardly is provided at the bottom of the substrate 214 closing to the front end, and a space for accommodating the extension plate 215, i.e., an accommodation slot 2141, is formed between the support portion 2143 and the rear end of the substrate 214. The support portion 2143 may be a support plate, a support bar, or other structure that meets the requirement.

In aforesaid embodiments, as shown in FIG. 6, the extension plate 215 and the substrate 214 are provided with a first anti-slip portion 2151 and a second anti-slip portion 2142, respectively, for the travelling device of the cleaning robot 10 to pass therethrough. The extension plate 215 is provided with the first anti-slip portion 2151 extending in a front-rear direction, and the substrate 214 is provided with the second anti-slip portion 2142. When the extension plate 215 is in the unfolded state, the extending direction of the first anti-slip portion 2151 coincides with the extending direction of the second anti-slip portion 2142, such that the travelling device of the cleaning robot 10, when approaching to the base station 20, may sequentially pass through the first anti-slip portion 2151 and the second anti-slip portion 2142 and dock on the base station 20. The first anti-slip portion 2151 and the second anti-slip portion 2142 are configured to contact with the driving wheel of the cleaning robot 10. Thus, the first anti-slip portion 2151 and the second anti-slip portion 2142 as provided may cause a certain friction with the driving wheel of the cleaning robot 10, which ensures that the cleaning robot 10 can move reliably to a suitable location of the base station 20 along the extension plate 215 and the substrate 214, and thereby enables the cleaning robot 10 to dock on the base station 20.

In some embodiments, the first anti-slip portion 2151 and/or the second anti-slip portion 2142 may be of an anti-slip uneven pattern, or other anti-slip structures that meet the requirement, which is not specifically limited by the present disclosure. The anti-slip uneven pattern may match with the tire pattern of the travelling device. For example, the anti-slip uneven pattern may be the same as the tire pattern of the travelling device, such that the first anti-slip portion 2151 and/or the second anti-slip portion 2142 can generate a sufficient friction with the tire to ensure that the cleaning robot 10 can quickly and smoothly dock at the appropriate location of the base station 20.

The slope portion 211 is provided with the second anti-slip portion 2142, which helps to ensure the cleaning robot 10 to climb the slope smoothly. It will be appreciated that the second anti-slip portion 2142 may be provided on the slope portion 211 and disposed on the substrate 214 between the slope portion 211 and the extension plate 215 to further improve the reliability of the cleaning robot 10 running on the substrate 214.

In some possible embodiments according to the present disclosure, the travelling device of the cleaning robot 10 includes a second travelling device symmetrically distributed along the running direction of the cleaning robot 10 as shown in FIG. 3, and the second travelling device may be a driving wheel. The first anti-slip portion 2151 is symmetrically provided on the extension plate 215, and the second anti-slip portion 2142 is symmetrically provided on the substrate 214. That is, there are two second anti-slip portions 2142, and they are provided symmetrically on both sides of the centerline of the substrate 214 along the front-rear direction; and there are also two first anti-slip portions 2151, and they are symmetrically provided on both sides of the centerline of the extension plate 215 along the front-rear direction, and the two first anti-slip portions 2151 are provided in correspondence with the two second anti-slip portions 2142. In this way, when the cleaning robot 10 approaches the base station baseboard 210, the two driving wheels as symmetrically distributed may sequentially pass through the first anti-slip portions as symmetrically distributed and the second anti-slip portions as symmetrically distributed, such that the two first anti-slip portions 2151 and the two second anti-slip portions 2142 can contact the two driving wheels correspondingly, thereby improving the stability and reliability of the cleaning robot in docking at the base station.

In some embodiments, as shown in FIG. 6, the extension plate 215 is provided with a first track 2191 extending in a front-rear direction, and the first anti-slip portion 2151 is provided in the first track 2191; the substrate 214 is provided with a second track 2192 extending in the front-rear direction, and the second anti-slip portion 2142 is provided in the second track 2192. When the extension plate 215 is in the unfolded state relative to the substrate 214, the extending direction of the first track 2191 coincides with the extending direction of the second track 2192, such that the cleaning robot 10, which is approaching the base station 20, sequentially pass through the first track 2191 and the second track 2192 to dock on the base station 20. The first track 2191 and the second track 2192 play a certain guide role for the tires of the second travelling device of the cleaning robot 10, such that the second travelling device can smoothly, quickly and accurately dock at a suitable location of the base station 20 along the first track 2191 and the second track 2192, thereby improving the docking efficiency and the docking accuracy of the cleaning robot 10 relative to the base station 20.

In some possible embodiments according to the present disclosure, the substrate 214 is provided with an avoidance slot. For example, the avoidance slot 2111 is provided on the slope portion 211, and is disposed between the two second anti-slip portions 2142 for accommodating a part of the cleaning robot 10 when the cleaning robot 10 passes through the base station baseboard 210. In normal cases, the driven wheel 142 and the driving wheel are provided at the bottom of the cleaning robot 10, which means that the second travelling device is provided at the bottom of the cleaning robot 10. Thus, by providing the avoidance slot 2111 on the slope portion 211, the avoidance slot 2111 can accommodate the driven wheel 142 or a part of the machine body 110 of the cleaning robot 10 during docking of the cleaning robot 10 to the base station 20, so as to prevent the machine body 110 of the cleaning robot 10 from projecting prematurely and causing a tail portion of the machine body 110 to come into contact with the base station baseboard 210 during docking of the cleaning robot 10 to the base station 20 which would otherwise increase the difficulty of the cleaning robot 10 in docking at the base station 20.

As shown in FIGS. 5, 6 and 7, the support wheels 2112 are provided on both sides of the avoidance slot 2111. For example, the support wheels 2112 are provided on the slope portion 211, and are disposed on two sides of the avoidance slot 2111 and may for example disposed between the avoidance slot 2111 and the second anti-slip portion 2142. Then, the bottom of the cleaning robot 10 is supported by the support wheel 2112, which helps to reduce the difficulty of the driving wheel in climbing the slope, and thereby improves the smoothness of the climbing. The axis of the support wheel 2112 is provided perpendicular to the front-rear direction.

In some embodiments, the substrate 214 further includes a flat portion 217 connected to the slope portion 211. The flat portion 217 is disposed between the slope portion 211 and the extension plate 215, which means that the flat portion 217 is disposed in front of the slope portion 211. The provision of the flat portion 217 increases the distance of the cleaning robot 10 from the ground to the slope portion 211, and provides a certain buffer distance for the climbing operation of the cleaning robot 10, thereby helping the cleaning robot 10 to climb the slope.

In some possible embodiments according to the present disclosure, as shown in FIG. 6, the travelling device of the cleaning robot 10 further includes a first travelling device. For example, the first travelling device may be provided at the front of the cleaning robot 10 and the second travelling device may be provided at the rear of the cleaning robot 10. By taking the moving direction of the cleaning robot as the front direction, the first travelling device is located in front of the second travelling device in the moving direction of the cleaning robot 10. Taking the embodiment shown in FIG. 3 as an example, when the cleaning robot 10 moves forwardly to dock at the base station 20, the driven wheel 142 is located in front of the driving wheel, which means that the first travelling device is the driven wheel 142 and the second travelling device is the driving wheel. It will be appreciated that, in other embodiments, the first travelling device may also be the driving wheel and the second travelling device may also be the driven wheel 142. Hereinafter, the embodiments according to the present disclosure are described by taking the first travelling device as the driven wheel 142 and the second travelling device as the driving wheel.

Since the first travelling device of the cleaning robot 10 is provided in front of the second travelling device, the first travelling device (e.g., driven wheel 142) may approach the base station 20 earlier than the second travelling device (e.g., driving wheel) when the cleaning robot 10 is required to move forwardly to dock at the base station 20. A recessed structure 212 is provided at the rear end of the extension plate 215 for the first travelling device among the travelling devices of the travelling device of the cleaning robot to pass therethrough. The recessed structure 212 opens upward and matches with the shape of the driven wheel 142 of the cleaning robot 10. Thus, when the cleaning robot 10 moves forwardly to approach the base station baseboard 210, the driven wheel 142 is firstly adapted to the recessed structure 212 when the extension plate 215 is in an unfolded state relative to the substrate 214. That is, the driven wheel 142 moves along the recessed structure 212 firstly after approaching the base station baseboard 210, which can postpone the lifting time of the cleaning robot 10 after contacting with the base station baseboard 210 and thereby help to improve the efficiency of the cleaning robot 10 in docking at the base station 20.

In some embodiments, the first travelling device is provided at the middle of the front part of the body of the cleaning robot 10, and the body herein may be the machine body 110 of the cleaning robot 10. For example, the driven wheels 142 may be generally provided in the geometric centerline of the cleaning robot 10 in the front-rear direction. In addition, because the recessed structure 212 is provided at the rear end of the extension plate 215 distal from the middle position, the extension plate 215 may have a large size in a direction perpendicular to the front-rear direction to ensure that the cleaning robot 10 can dock at the base station 20 through the base station baseboard 210; and this problem can be lessened by providing the recessed structure 212 at the middle position of the rear end of the extension plate 215. In other words, providing the recessed structure 212 at the middle position of the rear end of the extension plate 215 helps to reduce the size of the extension plate 215 in the direction perpendicular to the front-rear direction, and thereby reduces the space occupied by the base station baseboard 210, which can meet the design requirement that the base station has a compact structure. The recessed structure 212 extends in the direction toward the substrate 214, which helps to reduce the distance at which the cleaning robot 10 moves to the slope portion 211 through the recessed structure 212, and thereby can extend the lifting time of the cleaning robot 10 climbing the slope.

In aforesaid embodiments, as shown in FIG. 5, the recessed structure 212 is at least one of a notch and a recess. That is, the recessed structure 212 may be a notch, or the recessed structure 212 may be a recess, or alternatively the recessed structure 212 may be composed of both a notch and a recess. For example, the notch may be disposed in front of and interconnected with the recess, and the notch and the recess are combined to form the recessed structure. By providing different types of recessed structures 212, the requirement under different structures and different processing methods of the base station baseboard 210 can be met, which expands the usage range of the product.

In some embodiments, the recessed structure 212 is a notch. That is, the notch is provided at the rear end of the extension plate 215, and the notch extends in the direction toward the slope portion 211, such that the driven wheel 142 can move to the upper surface of the base station baseboard 210 after passing through the notch and further dock at a suitable location of the base station 20 after passing through the slope portion 211. The notch is easy to process and suitable for popularization and application.

In some embodiments, the recessed structure 212 includes a recess that is provided at the rear end of the extension plate 215 and has an opening backward. That is, a recess is provided at the rear end of the extension plate 215 and extends in the direction toward the slope portion 211, and the recess is an open slot. That is, the opening of the recess is communicated with the rear end portion of the extension plate 215, such that the driven wheel 142, when moving to the rear end of the extension plate 215, docks at a suitable location of the base station 20 after sequentially passing through the recess, the upper surface of the extension plate 215, the upper surface of the substrate 214, and the slope portion 211. The distance between the bottom of the recess and the lower surface of the extension plate 215 is too small to lift the cleaning robot 10, or the height as lifted may be rather small. Thus, the distance is negligible, and the same effect of postponing the lifting time of the cleaning robot 10 after contacting with the base station baseboard 210 can also be achieved. In addition, the design of the recess causes the distance between the bottom of the recess and the upper surface of the extension plate 215 to be appropriately reduced, which helps to reduce the difficulty of moving the driven wheel 142 from the recess to the upper surface of the extension plate 215, improves the smoothness and success rate of moving the driven wheel 142 from the recess to the upper surface of the base station baseboard 210, and thereby improves the efficiency of the cleaning robot 10 in docking at the base station 20.

In some possible embodiments according to the present disclosure, as shown in FIG. 6, a first guide surface 2121 is provided along the circumference of the recessed structure 212, and the first guide surface 2121 is provided slantwise from inside to outside. In some embodiments, the first guide surface 2121 is tilted from bottom to top in a direction away from the interior of the opening. The provision of the first guide surface 2121 plays a good guide role when the driven wheel 142 moves from the recessed structure 212 to the upper surface of the extension plate 215, which helps to reduce the difficulty of the driven wheel 142 in moving to the upper surface of the extension plate 215 from the recessed structure 212, improves the smoothness and success rate of the driven wheel 142 moving from the recessed structure 212 to the upper surface of the base station baseboard 210, and thereby improves the efficiency of the cleaning robot 10 in docking at the base station 20.

A side of the recessed structure 212 away from the rear end of the extension plate 215 is of an arching shape, and the arching shape matches with the shape of a part of the driven wheel 142.

In some possible embodiments according to the present disclosure, as shown in FIGS. 1, 11 and 13, the base station body 220 is provided with a guide portion 221 disposed above the substrate 214 for contacting with the cleaning robot 10. The contact of the guide portion 221 with the cleaning robot 10 can guide the cleaning robot 10 to move in a direction approaching the base station body 220, and can limit the movement of the cleaning robot 10 along the vertical direction, which helps to improve the smoothness and accuracy of the cleaning robot 10 docking on the base station body 220, and also improve the efficiency of the robot docking on the base station body 220.

In some embodiments, as shown in FIG. 6, the base station body 220 is further provided with a cleaning assembly 30 for cleaning the cleaning robot 10. In some embodiments, the cleaning assembly 30 is configured to clean the cleaning system 150 of the cleaning robot 10 along the vertical direction, and the guide portion 221 is disposed above the cleaning assembly 30. In other words, the cleaning assembly 30 is disposed at a side of the base station body 220 close to the base station baseboard 210 to clean the cleaning system 150 at the bottom of the cleaning robot 10. It will be appreciated that when the substrate 214 is provided with a cleaning slot 216 disposed below the cleaning assembly 30, the cleaning slot 216 is configured to accommodate debris and sewage as generated when the cleaning assembly 30 cleans the cleaning system 150 of the cleaning robot 10. At this point, the cleaning assembly 30 is disposed above the cleaning slot 216, and the guide portion 221 is disposed above the cleaning assembly 30, along the vertical direction. It will be appreciated that the cleaning slot 216 is disposed at a side of the slope portion 211 distal from the recessed structure 212.

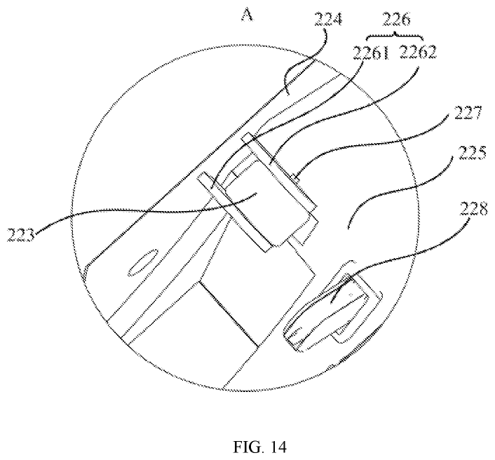

In aforesaid embodiments, as shown in FIGS. 13 and 14, the base station body 220 is provided with a top guide surface 224 opposite to the substrate 214, and the guide portion 221 is provided on the top guide surface 224 for contacting with the top of the cleaning robot 10. In other words, when the cleaning robot 10 docks to the base station body 220, the guide portion 221 contacts the top of the cleaning robot 10 from above to guide and limit the movement of the cleaning robot 10, which helps to reduce the size of the base station 20 in the horizontal direction, meets the demand that the layout space of the base station 20 has a small size in the horizontal direction, and thereby expands the usage range of the product.

On one hand, the guide portion 221 may be provided on the middle portion of the top guide surface 224, which makes it possible to guide and limit the movement of the cleaning robot 10 by only one guide portion 221 and which is simple in structure and low in cost.

On the other hand, the guide portion 221 may be provided on both sides of the middle portion of the top guide surface 224, which makes it possible to guide and limit the movement of the cleaning robot 10 by two guide portions 221, and which helps to improve the accuracy and smoothness of the movement of the cleaning robot 10 and improves the reliability and accuracy of the position limiting, thereby being suitable for popularization and application.

On the further other hand, the guide portion 221 may be provided in the middle portion and at both sides of the middle portion of the top guide surface 224, which makes it possible to guide and limit the movement of the cleaning robot 10 by three guide portions 221, and which can greatly improve the accuracy and smoothness of the movement of the cleaning robot 10 and improve the reliability and accuracy of the position limiting.

It will be appreciated that the number of the guide portions 221 may be one, two, three, four, five or other numbers meeting the requirements. By providing different numbers of guide portions 221, the needs of the different structures of the guide portion 221 can be met, and the needs of different precision in the direction guide and position limiting can be met, which expands the usage range of the product.

The guide portion 221 may be at least one of the guide press block 222 and the guide wheel 223. For example, the guide portion 221 may all be the guide press block 222; or the guide portion 221 may all be the guide wheel 223; or alternatively, the guide portion 221 may include the guide press block 222 and the guide wheel 223, at which point the number of guide portions 221 is at least two.

In some embodiments, the top guide surface 224 is provided with a guide portion 221 at a middle position, and the guide portion 221 may be the guide press block 222 or the guide wheel 223. Alternatively, the top guide surface 224 is provided with two guide portions 221 at either side of the middle position, and the two guide portions 221 may both be the guide press block 222 or the guide wheel 223, or one is the guide press block 222 and the other is the guide wheel 223. Alternatively, the top guide surface 224 is provided with three guide portions 221, which include the guide press block 222 or a guide wheel 223 at the middle position and the guide press block 222 or the guide wheel 223 at two sides of the middle position. For example, the guide press block 222 is provided at the middle position, and the guide wheel 223 is provided at two sides of the middle position.

In aforesaid embodiments, the guide portion 221 is provided at the front end of the top guide surface 224, and the cleaning robot 10 moves along the front-rear direction of the base station 20 and docks on the base station body 220 at the front. Thus, the guide portion 221 as provided on a side of the top guide surface 224 close to the front can guide the cleaning robot 10 to move to the docking point of the base station body 220 along the front-rear direction of the base station 20, which lessens the problem that the cleaning robot 10 cannot successfully move to the docking point of the base station body 220, and thereby improves the accuracy and reliability of the cleaning robot 10 docking at the base station 20.

As shown in FIGS. 13 and 14, the base station body 220 is further provided with a side guide surface 225 facing backward, and the side guide surface 225 is provided between the substrate 214 and the top guide surface 224. In some embodiments, the side guide surface 225 is provided above the cleaning assembly 30, and includes two side surfaces 2251 opposite to each other and an intermediate surface 2252 disposed between the two side surfaces 2251, the intermediate surface 2252 being opposite to the travelling direction in which the cleaning robot 10 approaches the base station 20.

In some possible embodiments according to the present disclosure, as shown in FIGS. 1 and 11, when the guide portion 221 includes a guide press block 222, a side of the guide press block 222 facing towards the substrate 214 is provided as a first slope 2221 sloping downwardly in a direction from back to front. When the cleaning robot 10 docks at the base station 20, the top of the cleaning robot 10 contacts the first slope 2221 of the guide press block 222 and moves along the first slope 2221 of the guide press block 222 in a direction approaching the base station body 220 until it reaches the docking point. In addition, the cleaning robot 10 may clean its cleaning system 150 when reaching the docking point of the base station 20, e.g., after docking at the base station 20. During the cleaning process, the cleaning assembly 30 of the base station 20 contacts the cleaning system 150 of the cleaning robot 10 and exerts a straight-up pushing force on the cleaning robot 10. The provision of the guide press block 222 can partially or fully counteract the straight-up pushing force and prevent the cleaning robot 10 from moving upward.

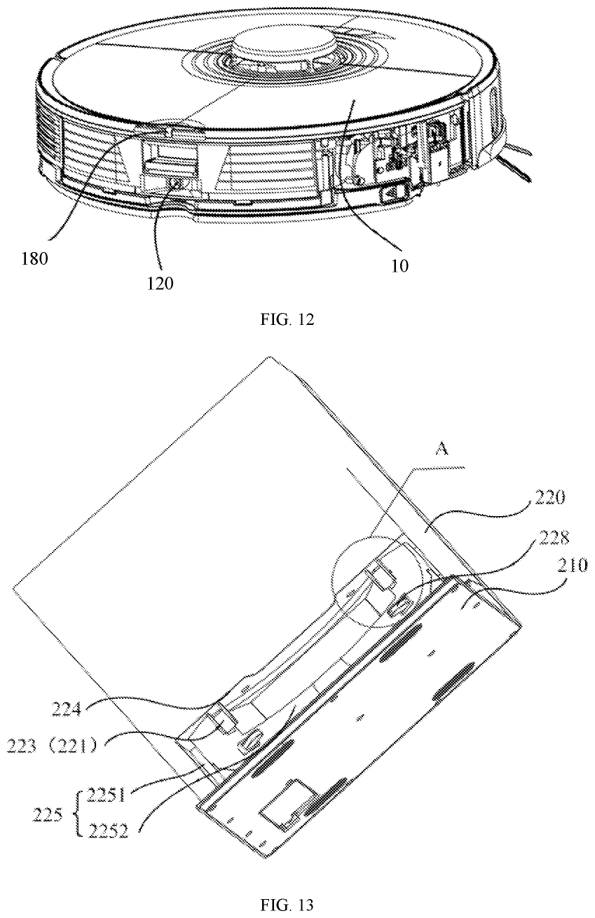

In some embodiments, as shown in FIGS. 11 and 12, a rotating wheel 180 matching with the guide press block 222 is provided on the upper side edge of the cleaning robot 10 to further facilitate docking of the cleaning robot 10 at the base station 20. As shown in FIG. 12, the rotating wheel 180 may rotate along an axis perpendicular to the front-rear direction of the base station 20, such that the rotating wheel 180 can mate with the guide press block 222 when the cleaning robot 10 needs to move to the docking point of the base station 20, thereby enabling the cleaning robot 10 to move more smoothly to the docking point of the base station 20. It will be appreciated that the rotating wheel 180 may be provided on the upper side edge of the cleaning robot 10 corresponding to the number and position of the guide press block 222.

In some embodiments, the cleaning robot 10 may have different postures when performing different operations while docking on the base station 20. For example, when the cleaning robot 10 docks on the base station 20 for charging, the forward portion 111 may approach the base station body 220 since a first charging contact pole piece is provided on the forward portion 111 of the cleaning robot 10. In other words, the cleaning robot 10 needs to move forwardly to dock on the base station 20.

When the cleaning robot 10 docks on the base station 20 to clean the cleaning system 150, the cleaning system 150 may be provided close to the forward portion 111 of the cleaning robot 10, or provided distal from the forward portion 111. When the cleaning system 150 is provided close to the forward portion 111 of the cleaning robot 10, the cleaning robot 10 can bring the forward portion 111 close to the base station body 220 to enable the base station 20 to clean the cleaning system. Under this state, the posture of the cleaning robot 10 relative to the base station 20 is the same during the charging and cleaning operations, which means that the cleaning robot 10 needs to move forwardly and dock on the base station 20.

When the cleaning system 150 is provided distal from the forward portion 111, it may be necessary to bring the backward portion 112 of the cleaning robot 10 close to the base station body 220 for cleaning. Under this state, the postures of the cleaning robot 10 with respect to the base station 20 are opposite during the charging and cleaning operations, which means that the cleaning robot 10 needs to reverse backward to dock on the base station 20 for the cleaning operation. Thus, a plurality of rotating wheels 180 may be provided at different locations of the upper side edge of the cleaning robot 10 to enable all the rotating wheels 180 to match with the guide press block 222 when the cleaning robot 10 docks on the base station 20 in different postures, thereby improving the docking efficiency.

In some possible embodiments according to the present disclosure, as shown in FIGS. 13 and 14, when the guide portion 221 includes a guide wheel 223, the guide wheel 223 rotates along an axis perpendicular to the front-rear direction of the base station 20. That is, the guide wheel 223 rotates reciprocally along the front-rear direction, such that the guide wheel 223 can guide the cleaning robot 10 to move in a direction close to or away from the base station body 220, thereby enabling the cleaning robot 10 to move to the docking point of the base station 20 more smoothly.

The provision of the guide wheel 223 can also limit the movement of the cleaning robot 10 in the vertical direction after the cleaning robot 10 docks on the base station 20. For example, when the cleaning robot 10 docks on the base station 20 for cleaning, the cleaning assembly 30 of the base station 20 comes into contact with the cleaning system 150 of the cleaning robot 10 and applies a straight-up pushing force to the cleaning robot 10. The provision of the guide wheel 223 may partially or fully counteract the straight-up pushing force and prevent the cleaning robot 10 from moving upward.

In this embodiment, the top guide surface 224 is provided with a mounting bracket 226, and the guide wheel 223 is mounted on the mounting bracket 226 by a rotation shaft 227. The provision of the mounting bracket 226 and the rotation shaft 227 enables the guide wheel 223 to be reliably and firmly fixed to the top guide surface 224 and to rotate around the rotation shaft 227 in a direction perpendicular to the front-rear direction of the base station 20. The rotation shaft 227 is arranged in a direction perpendicular to the front-rear direction of the base station 20.

In some embodiments, the mounting bracket 226 includes a first bracket body 2261 and a second bracket body 2262 that are provided opposite to each other, and the rotation shaft 227 is connected to the first bracket body 2261 and the second bracket body 2262. That is, the first bracket body 2261 and the second bracket body 2262 are spaced apart along a direction perpendicular to the front-rear direction of the base station 20, and the guide wheel 223 is sleeved to the rotation shaft 227 and is disposed between the first bracket body 2261 and the second bracket body 2262. When the cleaning robot 10 docks to the base station 20, the guide wheel 223 contacts the top of the cleaning robot 10 and rotates along the rotation shaft 227 to guide the cleaning robot 10 to move in the direction close to the base station body 220, such that the cleaning robot 10 can move to the docking point of the base station 20 more smoothly. The provision of the first bracket body 2261 and the second bracket body 2262 helps to improve the reliability and stability of the connection between the guide wheel 223 and the top guide surface 224.

All embodiments of the present disclosure may be performed alone or in combination with other embodiments, which are all considered to be within the protection scope claimed by the present disclosure.

The present disclosure has been illustrated by aforesaid embodiments, but it shall be understood that the aforesaid embodiments are merely exemplary and illustrative, and are not intended to limit the present disclosure to the scope of the embodiments as described. Further, it may be understood by those skilled in the art that the present disclosure is not limited to the aforesaid embodiments and that a greater variety of variations and modifications may be made in accordance with the teachings of the present disclosure, all of which fall within the protection scope as claimed by the present disclosure. The protection scope of the present disclosure is defined by the appended claims and their equivalent scope.

1. A base station for maintenance of a cleaning robot, comprising:
a base station body, and a base station baseboard having a slope portion tilted upward from back to front,
wherein the base station baseboard comprises a substrate and an extension plate, a front end of the substrate is engaged with the base station body, and a rear end of the substrate is connected to the extension plate.

2. The base station according to claim 1, wherein
the extension plate is pivotally connected to the substrate, and the extension plate has a folded state and an unfolded state with respect to the substrate.

3. The base station according to claim 2, wherein
an accommodation slot is provided at a bottom of the substrate, and the extension plate is accommodated in the accommodation slot when the extension plate is in the folded state.

4. The base station according to claim 1, wherein
first anti-slip portions and second anti-slip portions are respectively provided on the extension plate and the substrate for a travelling device of the cleaning robot to pass therethrough.

5. The base station according to claim 4, wherein
the first anti-slip portions are symmetrically provided on the extension plate, and the second anti-slip portions are symmetrically provided on the substrate.

6. The base station according to claim 5, wherein
the substrate is provided with an avoidance slot, the avoidance slot being provided between the second anti-slip portions and configured to accommodate a part of the cleaning robot when the cleaning robot passes through the base station baseboard.

7. The base station according to claim 6, wherein
a support wheel is provided at two sides of the avoidance slot, and configured to support the cleaning robot when the cleaning robot passes through or docks on the base station baseboard.

8. The base station according to claim 1, wherein
a recessed structure is provided at a rear end of the extension plate for the travelling device of the cleaning robot to pass therethrough.

9. The base station according to claim 8, wherein
the recessed structure is located at a middle position of the rear end of the extension plate.

10. The base station according to claim 8, wherein
a first guide surface is provided along a circumference of the recessed structure, and is provided slantwise from inside to outside.

11. The base station according to claim 1, wherein
the base station body is provided with a guide portion disposed above the substrate for contacting with the cleaning robot.

12. The base station according to claim 11, wherein
the base station body is provided with a top guide surface opposite to the substrate, and the guide portion is provided on a middle portion of the top guide surface and/or at two sides of the middle portion.

13. The base station according to claim 12, wherein
the guide portion is provided at a front end of the top guide surface.

14. The base station according to claim 12, wherein
the guide portion comprises a guide press block, wherein a side of the guide press block facing the substrate is provided as a first slope, and the first slope is tilted downward from back to front.

15. The base station according to claim 12, wherein
the guide portion comprises a guide wheel, and the guide wheel rotates about an axis perpendicular to a front-rear direction of the base station.

16. The base station according to claim 15, wherein
the top guide surface is provided with a mounting bracket, and the guide wheel is mounted to the mounting bracket by a rotation shaft.

17. A cleaning robot system comprising:
a cleaning robot; and
a base station, the cleaning robot being adapted to dock at the base station, wherein
the base station comprises:
a base station body, and a base station baseboard having a slope portion tilted upward from back to front,
wherein the base station baseboard comprises a substrate and an extension plate, a front end of the substrate is engaged with the base station body, and a rear end of the substrate is connected to the extension plate.

18. The cleaning robot system according to claim 17, wherein
the extension plate is pivotally connected to the substrate, and the extension plate has a folded state and an unfolded state with respect to the substrate.

19. The cleaning robot system according to claim 17, wherein
first anti-slip portions and second anti-slip portions are respectively provided on the extension plate and the substrate for a travelling device of the cleaning robot to pass therethrough.

20. The cleaning robot system according to claim 17, wherein
a recessed structure is provided at a rear end of the extension plate for the travelling device of the cleaning robot to pass therethrough.
